(19) United States
(12) Patent Application Publication
(10) Pub. No.: US 2015/0171504 A1
(43) Pub. Date: Jun. 18, 2015

(54) ELECTRONIC APPARATUS

(71) Applicant: Kabushiki Kaisha Toshiba, Tokyo (JP)

(72) Inventor: Hiroyuki Hotta, Ome-shi (JP)

(21) Appl. No.: 14/460,153

(22) Filed: Aug. 14, 2014

Related U.S. Application Data
(60) Provisional application No. 61/915,978, filed on Dec. 13, 2013.

(51) Int. Cl. H01Q 1/22

(52) U.S. Cl. CPC H01Q 1/2266

(57) ABSTRACT

According to one embodiment, an electronic apparatus includes a housing, an electronic component in the housing, and an antenna in the housing. The antenna includes a feed point, and an antenna element pattern located between the feed point and the electronic component.

### CROSS-REFERENCE TO RELATED APPLICATIONS

This application claims the benefit of U.S. Provisional Application No. 61/915,978, filed Dec. 13, 2013, the entire contents of which are incorporated herein by reference.

### FIELD

Embodiments described herein relate generally to electronic apparatus.

### BACKGROUND

Electronic apparatuses comprising a housing and an antenna are provided.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an electronic apparatus according to a first embodiment.

FIG. 2 is an exemplary sectional view of part of a display housing of the electronic apparatus shown in FIG. 1.

FIG. 3 is an exemplary plan view of an inside of the display housing of the electronic apparatus shown in FIG. 1.

FIG. 4 illustrates examples of a model of a first simulation.

FIG. 5 illustrates an example of a result of the first simulation.

FIG. 6 illustrates an example of the result of the first simulation.

FIG. 7 is an exemplary plan view of an inverted-F element according to the first embodiment.

FIG. 8 is an exemplary plan view of a folded element according to the first embodiment.

FIG. 9 illustrates an example of a result of a second simulation.

FIG. 10 illustrates an example of the result of the second simulation.

FIG. 11 is an exemplary plan view of a form of an antenna according to the first embodiment.

FIG. 12 illustrates an example of a result of a third simulation.

FIG. 13 illustrates an example of the result of the third simulation.

FIG. 14 is an exemplary plan view of an inside of an electronic apparatus according to a second embodiment.

### DETAILED DESCRIPTION

Various embodiments will be described hereinafter with reference to the accompanying drawings.

In general, according to one embodiment, an electronic apparatus comprises a housing, an electronic component in the housing, and an antenna in the housing. The antenna comprises a feed point, and an antenna element pattern located between the feed point and the electronic component.

In this specification, some components are expressed by two or more terms. These terms are merely examples. The components may be further expressed by another or other terms. The other components which are not expressed by two or more terms may be expressed by another or other terms.

### First Embodiment

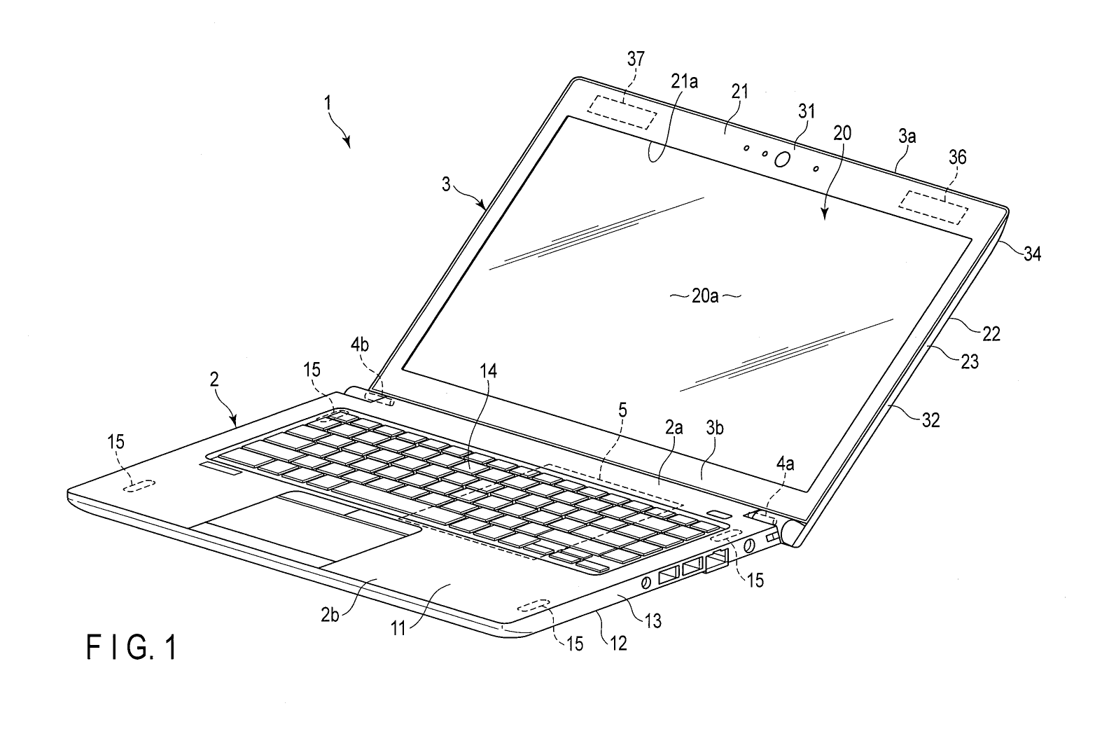

FIGS. 1 to 13 illustrate an electronic apparatus 1 according to a first embodiment. The electronic apparatus 1 is, for example, a notebook computer (i.e., notebook PC). It should be noted that an electronic apparatus to which this embodiment can be applied is not limited to the above example. This embodiment can be widely applied to various electronic apparatuses such as television receivers, tablet (i.e., slate) portable computers, cellular phones (including smartphones) and game consoles.

As shown in FIG. 1, the electronic apparatus 1 comprises a first housing 2, a second housing 3 and a pair of hinges 4a and 4b. The first housing 2 is, for example, a main housing. For example, a circuit board 5 as a main board is provided in the first housing 2. The first housing 2 comprises an upper wall 11, a lower wall 12 (i.e., bottom wall) and a peripheral wall 13, and is formed to be a flat box. Herein, the front, rear, left and right sides are defined as viewed from a user.

The upper wall 11 extends in a longitudinal direction (e.g., substantially horizontal direction) of the first housing 2. A keyboard 14 as an input portion is attached to the upper wall 11. It should be noted that the input portion provided on the upper wall 11 is not limited to a keyboard, and can be, for example, a touchpanel (i.e., touch sensor) or other input devices.

The lower wall 12 is located opposite to the upper wall 11. The lower wall 12 extends, for example, substantially parallel to the upper wall 11. When the electronic apparatus 1 is put on a desk, the lower wall 12 faces the upper surface of the desk (i.e., external placement surface). The lower wall 12 comprises, for example, a plurality of feet 15 (i.e., supporting portions). When the electronic apparatus 1 is put on the desk, the feet 15 contact the upper surface of the desk and support the electronic apparatus 1.

The peripheral wall 13 extends in a direction crossing the upper wall 11 and the lower wall 12, and connects a peripheral portion of the lower wall 12 and that of the upper wall 11. The peripheral wall 13 extends in a thickness direction of the first housing 2. Also, the first housing 2 comprises a first end 2a (e.g., rear end) and a second end 2b (e.g., front end) located opposite to the first end 2a.

On the other hand, the second housing 3 is, for example, a display housing. A display 20 (i.e., display module or unit) is provided in the second housing 3. The display 20 is an example of each of an electronic component, a component, a component comprising a metal portion, and a metal portion. Although an example of the display 20 is a liquid crystal display, the display 20 is not limited to this. The display 20 comprises a display screen 20a on which an image is displayed.

The second housing 3 comprises the front wall 21 (i.e., first wall), the back wall 22 (i.e., second wall) and the peripheral wall 23 (i.e., sidewall or third wall), and is formed to be a flat box. An opening 21a for exposing the display screen 20a is provided on the front wall 21. The back wall 22 is located opposite to the front wall 21, and covers the back surface of the display 20. The peripheral wall 23 extends in a direction crossing the front wall 21 and the back wall 22, and connects a peripheral portion of the front wall 21 and that of the back wall 22. The second housing 3 comprises a first end 3a (e.g., upper end) and a second end 3b (e.g., lower end) located opposite to the first end 3a.

The hinges 4a and 4b rotatably (i.e., openably and closably) connect the first end 2a of the first housing 2 and the second end 3b of the second housing 3. Thus, the electronic apparatus 1 is openable and closable (i.e., deformable or foldable). The second housing 3 is rotatable between a first state (e.g., closed state) in which the first housing 2 and the second housing 3 overlap each other, and a second state (e.g., open state) in which the second housing 3 is raised from the first housing 2.

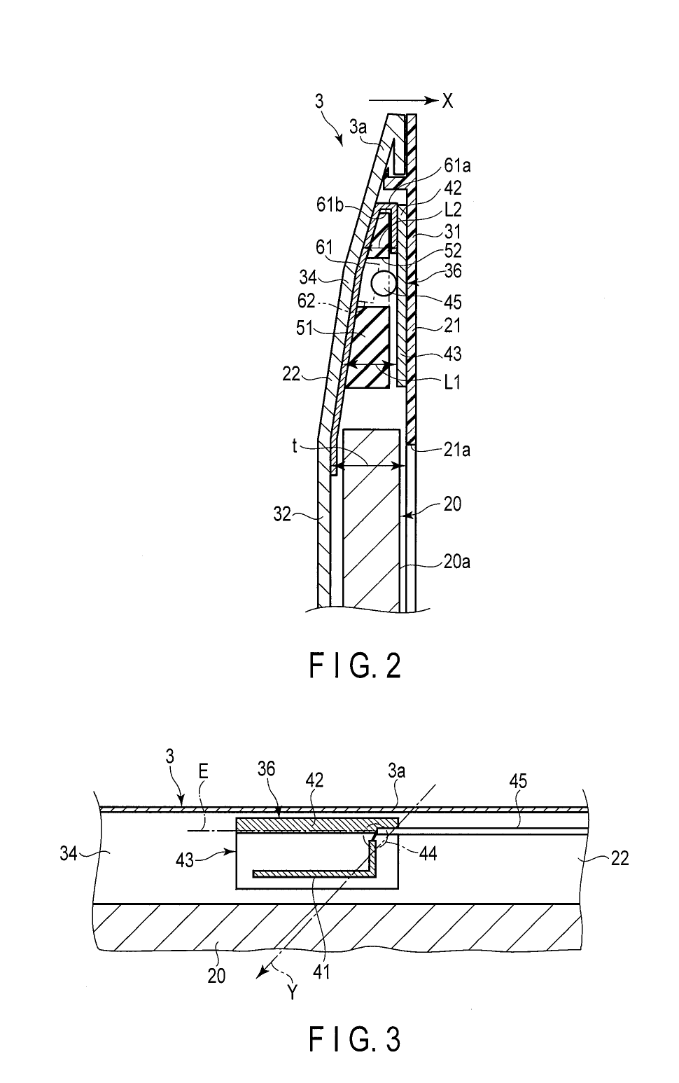

As shown in FIG. 2, the second housing 3 comprises a mask 31 (i.e., front cover) and a cover 32 (i.e., back cover). The mask 31 is an example of a first member. The mask 31 comprises a front wall 21. The cover 32 is an example of a second member. The cover 32 comprises a back wall 22 and a peripheral wall 23, and is located opposite to the mask 31. The mask 31 and the cover 32 are combined, and thereby the second housing 3 is formed.

As shown in FIG. 2, the back wall 22 of the second housing 3 comprises an inclined portion 34 approaching the front wall 21 as approaching the first end 3a. The inclined portion 34 reaches the first end 3a, and contacts the front wall 21 at the first end 3a.

Accordingly, the second housing 3 is formed to be in a tapered shape with the second housing 3 tapered toward the first end 3a. The second housing 3 according to this embodiment comprises the inclined portion 34 in an arc shape, and is rounded. It should be noted that the inclined portion 34 is not necessarily in the arc shape. It may be linearly inclined toward, for example, the front wall 21.

The mask 31 is formed of, for example, synthetic resin. The cover 32 is formed of, for example, metal. In this embodiment, the whole of the cover 32 comprising the first end 3a and the inclined portion 34 (that is, the whole of the back wall 22 and the peripheral wall 23) is formed of metal.

Next, a mounting structure of antennas 36 and 37 will be described.

As shown in FIG. 1, the antennas 36 and 37 are provided in the second housing 3. The antennas 36 and 37 are located between the first end 3a of the second housing 3 and the display 20. It should be noted that the mounting structure of the antenna 36 will be hereinafter described in detail. Since the antenna 37 comprises a mounting structure substantially identical to that of the antenna 36 to be described, its detailed explanation will be omitted. Also, the second housing 3 is hereinafter referred to simply as a “housing 3.”

As shown in FIG. 2, the antenna 36 is located between the inclined portion 34 of the back wall 22 and the front wall 21. It should be noted that the housing 3 according to this embodiment is formed to be comparatively thin with respect to a wavelength of a frequency band at which the antenna 36 resonates. For example, thickness t of the housing 3 (that is, distance between the back wall 22 and the front wall 21) is less than or equal to 1/24 of a wavelength of a radio wave at which the antenna 36 resonates. For example, in this embodiment, a frequency at which the antenna 36 resonates is the 2.5-GHz band, and thickness t of the housing 3 is less than or equal to 5 mm, which is 1/24 of the wavelength (approximately 120 mm) of the radio wave in the 2.5-GHz band.

As shown in FIG. 3, the antenna 36 comprises an antenna element pattern 41 (i.e., antenna element) and an antenna ground 42. In this embodiment, one antenna board 43 comprises the antenna element pattern 41 and the antenna ground 42 so that the antenna element pattern 41 and the antenna ground 42 are located on the same plane.

It should be noted that FIG. 3 shows the antenna 36 comprising an L-shaped monopole element as an example, but the antenna 36 according to this embodiment is not limited to this. For example, an inverted-F element and a folded element to be described can be properly applied to the antenna 36.

As shown in FIG. 3, the antenna ground 42 (i.e., ground plate) is formed, for example, in a plate shape. A feed point 44 (i.e., feed portion) of the antenna 36 is provided between the antenna element pattern 41 and the antenna ground 42. An antenna cable 45 for supplying electricity is connected to the feed point 44. The antenna cable 45 is an example of a cable.

The antenna cable 45 is, for example, a coaxial cable, and comprises a core wire and a ground portion. A current (i.e., signal) concerning transmission and reception of the antenna 36 flows through the core wire. The core wire of the antenna cable 45 is electrically connected to the antenna element pattern 41 at the feed point 44. The ground portion of the antenna cable 45 is electrically connected to the antenna ground 42. Accordingly, the antenna 36 is fed through the antenna cable 45.

As shown in FIG. 3, in this embodiment, the antenna 36 is arranged over the display 20 with the antenna element pattern 41 under the antenna ground 42. That is, the antenna 36 is arranged to keep the antenna element pattern 41 separated from the first end 3a of the housing 3.

Thus, in this embodiment, the antenna element pattern 41 is apart from the first end 3a of the housing 3. Also, the antenna element pattern 41 is closer to the display 20 (i.e., electronic component) than the antenna ground 42 and the feed point 44.

In another expression, the antenna element pattern 41 is located between the feed point 44 and the display 20. In other words, the feed point 44 is located between the first end 3a of the housing 3 and the antenna element pattern 41.

As shown in FIG. 3, an end portion of the antenna cable 45 extends substantially parallel to, for example, the first end 3a of the second housing 3. In this embodiment, the antenna element pattern 41 is located between a virtual extended line E of the end portion of the antenna cable 45 and the display 20. Also, in another viewpoint, at least part of the antenna element pattern 41 is located between the end portion of the antenna cable 45 and the display 20 in direction Y crossing (e.g., obliquely crossing) a direction in which the end portion of the antenna cable 45 extends.

As shown in FIG. 2, the antenna board 43 is arranged apart from the back wall 22 of the housing 3. A supporting portion 51 is provided between the antenna board 43 and the back wall 22 of the housing 3. The supporting portion 51 is a mold member formed of, for example, ABS resin. The supporting portion 51 holds the antenna board 43, and is fixed to the inner surface of the back wall 22 of the housing 3.

The antenna board 43 is supported by the supporting portion 51, and closer to the front wall 21 of the housing 3 than to the back wall 22 of the housing 3. The antenna board 43 is substantially parallel to the front wall 21. That is, the antenna element pattern 41 and the antenna ground 42 are substantially parallel to the front wall 21.

Thus, as shown in FIG. 2, in thickness direction X of the second housing 3, length L1 between the antenna element pattern 41 and the inner surface of the back wall 22 is greater than length L2 between the antenna ground 42 and the inner surface of the back wall 22. Also, length L1 between the antenna element pattern 41 and the inner surface of the back wall 22 is greater than the length between the feed point 44 and the inner surface of the back wall 22.

As shown in FIG. 2, in this embodiment, at least part of the antenna cable 45 is located between the antenna 36 (i.e., antenna board 43) and the back wall 22 of the housing 3 in thickness direction X of the second housing 3. An escape portion 52 for avoiding the antenna cable 45 is provided in the supporting portion 51. The escape portion 52 is a depression, a groove or a hole corresponding to the antenna cable 45. The escape portion 52 avoids interference between the supporting portion 51 and the antenna cable 45.

As shown in FIG. 2, a conductive tape 61 having flexibility is provided between the antenna 36 and the back wall 22 of the housing 3. The conductive tape 61 is electrically connected to the antenna ground 42, and is attached to the inclined portion 34 of the back wall 22 between the feed point 44 of the antenna 36 and the first end 3a of the housing 3. Then, the antenna ground 42 and the inclined portion 34 of the back wall 22 are electrically connected. Accordingly, the antenna ground 42 is grounded on the metal back wall 22.

The conductive tape 61 is an example of a conductive member. It should be noted that the conductive member is not especially limited if it electrically connects the antenna ground 42 and the back wall 22, and can be, for example, a connection member without flexibility.

It should be noted that a conductive gasket 62 (i.e., second conductive member) may be provided between the antenna cable 45 and the back wall 22 of the housing 3, as indicated by a two-dot chain line in FIG. 2. The gasket 62 electrically connects the ground portion of the antenna cable 45 and the back wall 22 of the housing 3. As a result, ground connection of the antenna cable 45 is reinforced and antenna characteristics can be further stabilized.

It should be noted that in this embodiment, since the antenna ground 42 is closer to the first end 3a of the housing 3 than the antenna element pattern 41, length L2 between the antenna ground 42 and the inner surface of the back wall 22 is smaller than length L1 between the antenna element pattern 41 and the inner surface of the back wall 22. Thus, according to the structure of this embodiment, thinning and weight reduction of the gasket 62 can be achieved. This contributes to the thinning and weight reduction of the electronic apparatus 1.

The conductive tape 61 is soldered on, for example, the antenna ground 42. This allows the connection between the conductive tape 61 and the antenna ground 42 to be more secured. As shown in FIG. 2, the conductive tape 61 extends from the antenna ground 42 toward the first end 3a of the housing 3, is bent (e.g., folded) to cover the feed point 44 and the antenna cable 45 from a side opposite to the display 20, and is attached to the inner surface of the back wall 22 of the housing 3.

To be specific, the conductive tape 61 comprises the first surface 61a comprising an adhesive layer (i.e., adhesive) and a second surface 61b located opposite to the first surface 61a. The conductive tape 61 is bent with the first surface 61a outside. A first end of a first surface 61a is attached to the antenna 36. A second end of the first surface 61a is attached to the inner surface of the back wall 22 of the housing 3.

Such a structure allows an electronic apparatus bringing good antenna performance to be provided.

A general electronic apparatus comprises a cover for antenna formed of synthetic resin in a portion corresponding to an antenna, if, for example, a metal housing is adopted. This allows the performance of the antenna provided in a metal housing to be secured.

However, a desire to remove the antenna cover formed of synthetic resin and to form the whole back wall of the housing of metal has been growing, for example, to achieve high quality or differentiation in design. However, in the case where an antenna is mounted in the same manner as before, the distance between the antenna and a metal housing becomes closer and the good antenna performance is not achieved if the whole back wall of the housing is formed of metal. On the other hand, since electronic apparatuses of recent years are requested to be thinner and to comprise a narrow frame, the housing cannot be thickened, or the frame cannot be widened.

Then, the electronic apparatus 1 according to this embodiment comprises the housing 3, the display 20 (i.e., electronic component) provided in the housing 3, and the antenna 36 provided in the housing 3. The antenna element pattern 41 of the antenna 36 is located between the feed point 44 and the display 20. According to such a structure, the distance between the antenna element pattern 41 and the metal portion of the housing 3 can be made longer, and good antenna performance can be secured.

In this embodiment, the antenna element pattern 41 is located more apart from the end 3a of the housing 3 than the feed point 44. According to such a structure, the distance between the antenna element pattern 41 and the metal portion of the housing 3 can be easily made longer, and good antenna performance can be further secured.

In addition, in this embodiment, the antenna element pattern 41 is located between at least part of the antenna cable 45 and the display 20. According to such a structure, the distance between the antenna element pattern 41 and the metal portion of the housing 3 can be easily made longer, and good antenna performance can be further secured.

In this embodiment, the housing 3 comprises the front wall 21 and the metal back wall 22 located opposite to the front wall 21. The back wall 22 comprises the inclined portion 34 approaching the front wall 21 as approaching the end 3a of the housing 3. The antenna 36 is located between the front wall 21 and the inclined portion 34 of the back wall 22.

According to such a structure, the distance between the antenna element pattern 41 and the metal portion of the housing 3 can be made longer by arranging the antenna element pattern 41 apart from the end 3a of the housing 3. This allows good antenna performance to be secured.

In this embodiment, the antenna element pattern 41 is arranged substantially parallel to the front wall 21. According to such a structure, the distance between the antenna element pattern 41 and the metal back wall 22 of the housing 3 can be further made longer. This allows the antenna performance to be further secured.

In this embodiment, the antenna 36 comprises the antenna ground 42 located between the end 3a of the housing 3 and the feed point 44. According to such a structure, the antenna element pattern 41 can be separated from the end 3a of the housing 3, and the antenna 36 can be arranged in the vicinity of the end 3a of the housing 3. This allows good antenna performance to be secured without increasing the area necessary to mount the antenna 36.

In this embodiment, it further comprises the conductive tape 61 for electrically connecting the antenna ground 42 and the back wall 22 between the end 3a of the housing 3 and the feed point 44. Such a structure allows the antenna ground 42 to be grounded on the back wall 22 in the vicinity of an edge of the metal back wall 22.

Generally, if a current flows through a flat member, the current flows easily along an edge of a member, not in the center of the member. Thus, the current easily flows along an edge of a metal housing when the antenna ground 42 and the back wall 22 are electrically connected in the vicinity of the edge of the back wall 22 as in this embodiment. This allows the antenna performance to be further improved.

In this embodiment, part of the antenna cable 45 is located between the antenna 36 and the inner surface of the back wall 22 of the housing 3. According to such a structure, space between the antenna 36 and the back wall 22 of the housing 3 can be effectively utilized, and the housing 3 can be thinned. This contributes to thinning of the electronic apparatus 1.

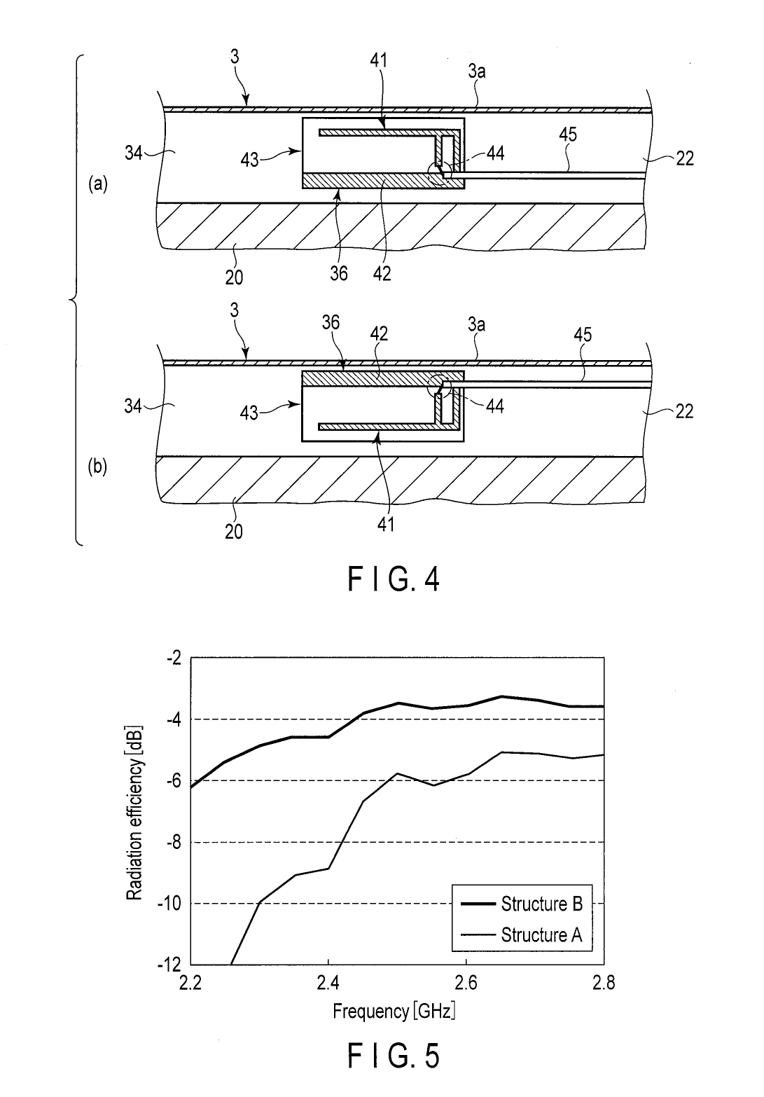

Next, a first simulation according to this embodiment will be described with reference to FIGS. 4 to 6.

FIG. 4 illustrates a mounting model of an antenna used in the first simulation. In the structure of (a) of FIG. 4, the feed point 44 is closer to the display 20 than the antenna element pattern 41 (hereinafter referred to as structure A). In the structure of (b) of FIG. 4, the antenna element pattern 41 is closer to the display 20 than the feed point 44 (hereinafter referred to as structure B).

In a housing shape shown in FIG. 2, a simulation condition is set as below. The whole of the cover 32 of the housing 3 is formed of metal, thickness t of the housing 3 is 3.5 mm, the antenna element pattern 41 is an inverted-F shaped element to be described in detail with reference FIG. 7, and the antenna is an antenna which resonates at around 2.5 GHz. It should be noted that the simulation is performed by an analytic method using a moment method.

FIG. 5 illustrates a simulation result of radiation efficiency (mismatch loss not included). As shown in FIG. 5, it is understood that the radiation efficiency of structure B becomes higher than that of structure A.

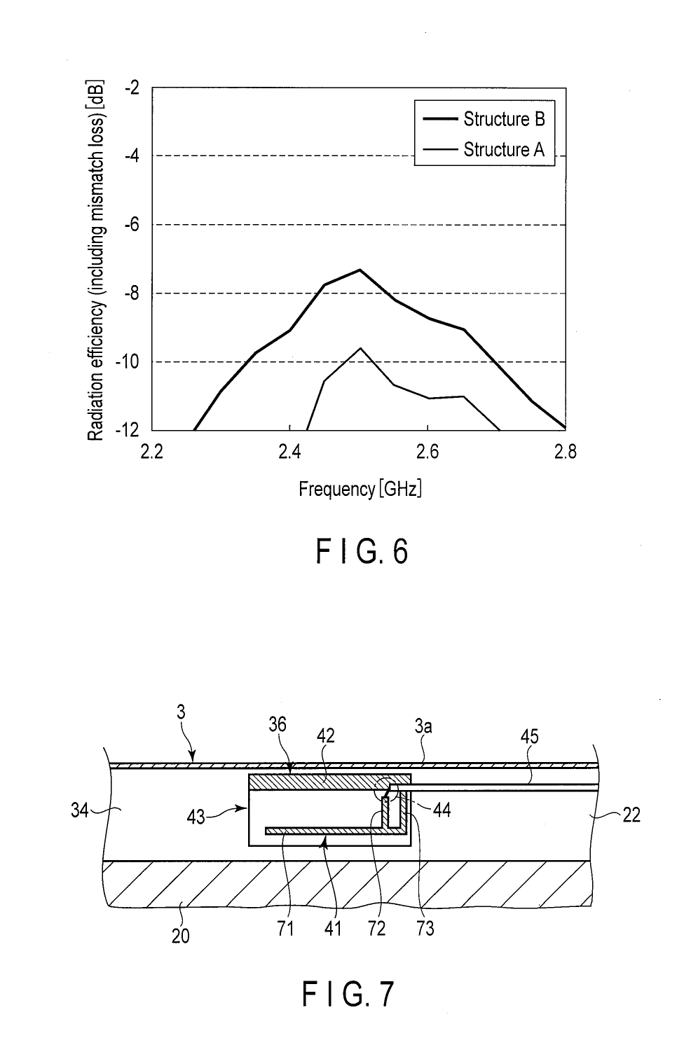

FIG. 6 illustrates a simulation result of the radiation efficiency to which the mismatch loss is also added. As shown in FIG. 6, it is understood that the radiation efficiency of structure B becomes higher than that of structure A in a certain band centered on 2.5 GHz. From the results, it can be confirmed that the radiation efficiency becomes higher in the mounting structure of structure B than in that of structure A.

Next, a second simulation according to this embodiment will be described with reference to FIGS. 7 to 10.

The second simulation shows a difference in impedance (VSWR) when the shape of the antenna element pattern 41 is somewhat changed in the mounting model of structure B of the first simulation. It should be noted that the condition other than the shape of the antenna element pattern 41 is identical to that of the first simulation.

FIG. 7 illustrates the antenna element pattern 41 of the inverted-F shaped element (hereinafter referred to as inverted-F element). The antenna element pattern 41 comprises a main portion 71 extending substantially parallel to the antenna ground 42, a feed portion 72 extending between the main portion 71 and the feed point 44, and a grounding portion 73 connecting an end of the main portion 71 and the antenna ground 42.

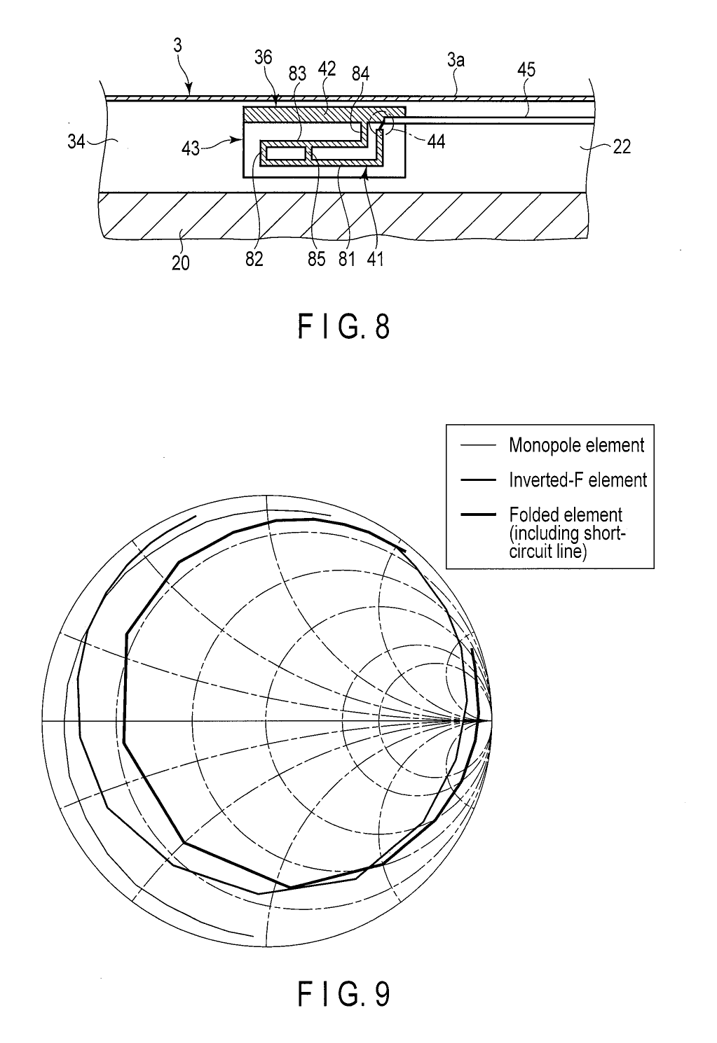

FIG. 8 illustrates the antenna element pattern 41 of an element comprising a folded shape and a short-circuit line (hereinafter referred to as a folded element [including short-circuit line]). The antenna element pattern 41 comprises a first half portion 81, a folded portion 82, a second half portion 83, a grounding portion 84 and a short-circuit portion 85 (i.e., short-circuit line). The core of the antenna cable 45 is electrically connected to the first half portion 81.

The first half portion 81 and the second half portion 83 extend substantially parallel to the antenna ground 42. The first half portion 81 extends toward an end of the antenna element. The folded portion 82 connects an end of the first half portion 81 and that of the second half portion 83. The grounding portion 84 connects the other end of the second half portion 83 and the antenna ground 42. The short-circuit portion 85 connects an intermediate portion of the first half portion 81 and that of the second half portion 83.

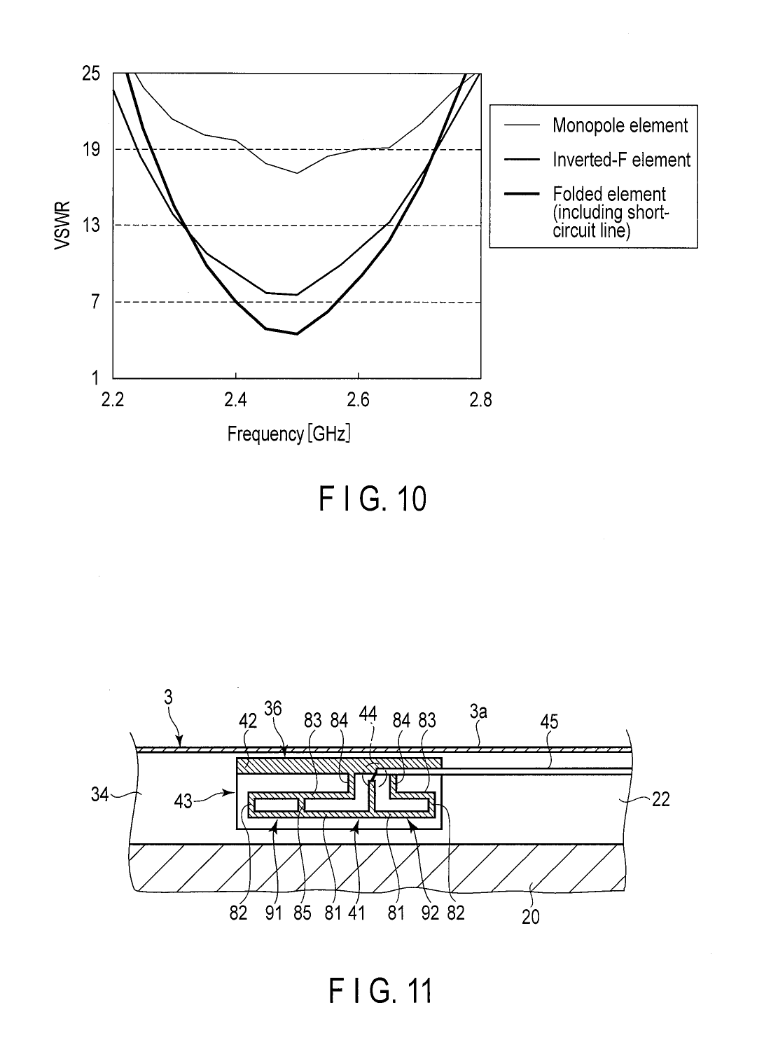

FIG. 9 illustrates a simulation result of Smith chart when the monopole element shown in FIG. 3, the inverted-F element shown in FIG. 7 and the folded element (including short-circuit line) shown in FIG. 8 are applied. Also, FIG. 10 illustrates a simulation result of a difference in VSWR when the monopole element, inverted-F element and folded element (including short-circuit line) are applied.

As shown in FIG. 9, it is understood that of the three antenna elements, the folded element (including short-circuit line), the inverted-F element and the monopole element are located more inside a circle in this order. As a result, the inverted-F element and the folded element have higher impedance than the monopole element.

Thus, as shown in FIG. 10, it is understood that the folded element (including short-circuit line), the inverted-F element and the monopole element have smaller VSWR values at around 2.5 GHz in this order. That is, regarding the inverted-F element and the folded element, the mismatch loss of the impedance is reduced in comparison with the case where the monopole element is used. Thus, it is understood that they are effective as antenna elements to be mounted when the whole of the cover 32 is formed of metal.

Next, a third simulation according to this embodiment will be described with reference to FIGS. 11 to 13.

The third simulation shows radiation efficiency and VSWR when the shape of the antenna element pattern 41 is changed in the mounting model of structure B of the first simulation. It should be noted that the condition other than the shape of the antenna element pattern 41 is identical to that of the first simulation.

FIG. 11 shows a shape of the antenna element pattern 41 used for this simulation. The antenna element pattern 41 comprises a resonating shape in two frequency bands (for example, 2.5- and 5-GHz bands). That is, the antenna element pattern 41 comprises a first portion 91 corresponding to the 2.5-GHz band and a second portion 92 corresponding to the 5-GHz band. It should be noted that structures having a function identical or similar to the folded element in FIG. 8 with respect to the shapes of the first portion 91 and the second portion 92 will be denoted by the same reference numbers, and their explanations will be omitted.

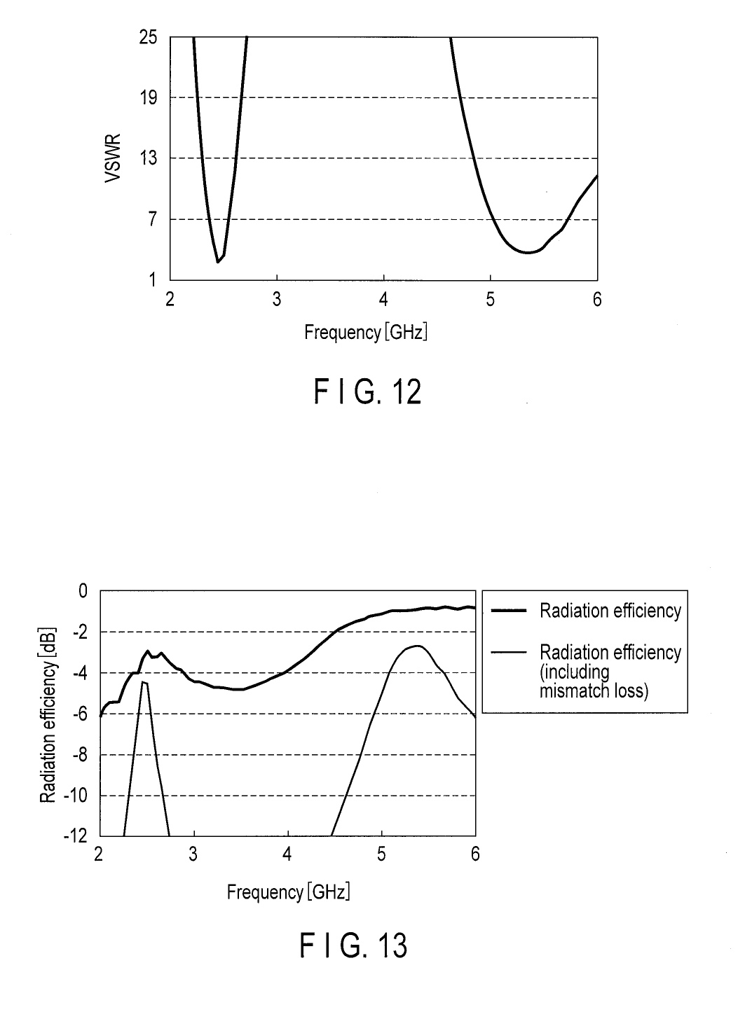

FIG. 12 illustrates a simulation result of VSWR when the antenna element pattern 41 of FIG. 11 is applied. As shown in FIG. 12, it is understood that according to the antenna element pattern 41, VSWR decreases at around 2.5 GHz and around 5 GHz, and good impedance can be achieved.

FIG. 13 illustrates a simulation result of radiation efficiency when the antenna element pattern 41 of FIG. 11 is applied. As shown in FIG. 13, it is understood that according to the antenna element pattern 41, good radiation efficiency can be achieved at around 2.5 GHz and around 5 GHz.

### Second Embodiment

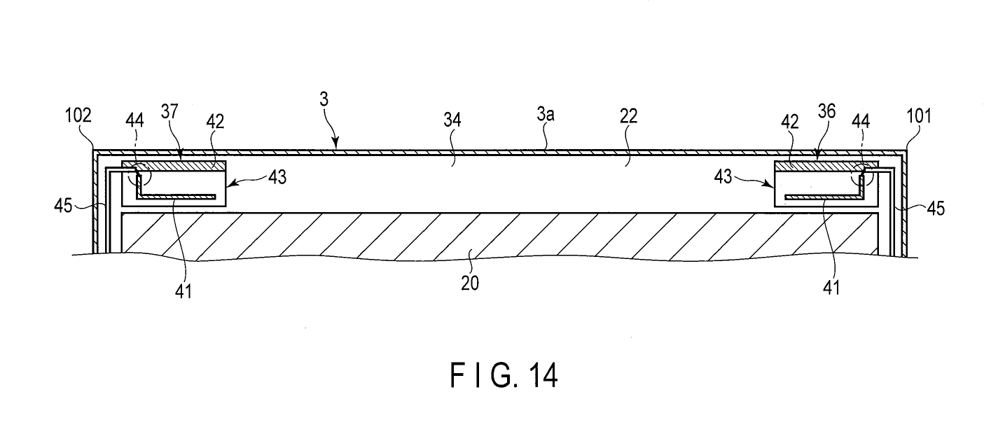

Next, the electronic apparatus 1 according to a second embodiment will be described with reference to FIG. 14. Structures having functions identical or similar to the structures in the first embodiment will be denoted by the same reference numbers, and their explanations will be omitted. Also, structures other than those to be described below are identical to those in the first embodiment.

As shown in FIG. 14, the housing 3 comprises a pair of corner portions 101 and 102. The pair of corner portions 101 and 102 are separately located at the right and left ends of the first housing 2. The antennas 36 and 37 are arranged in the corner portions 101 and 102, respectively.

Such a structure allows the length of the antenna cable 45 to be shorter than in the first embodiment. This contributes not only to improvement of antenna performance caused by the shortened cable but to weight and cost reduction of the electronic apparatus 1.

Although the first and second embodiments have been described, embodiments of the present invention are not limited to them. For example, an electronic component provided in the housing 3 is not limited to a display, and can be, for example, a circuit board, a battery, a hard disk drive (HDD), an optical disk drive (ODD) or other components.

Furthermore, the whole of the back wall 22 of the housing 3 is not necessarily formed of metal. For example, the distance between a metal portion of the back wall 22 of the housing 3 and the antenna element pattern 41 can be increased by applying the structures of the first and second embodiments to the housing 3 comprising the metal portion in a position closer to the first end 3a than the antenna element pattern 41.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing;
an electronic component in the housing; and
an antenna in the housing, the antenna comprising a feed point and an antenna element pattern located between the feed point and the electronic component.

2. The electronic apparatus of claim 1,
wherein the antenna element pattern is located more apart from an end of the housing than the feed point.

3. The electronic apparatus of claim 1, further comprising a cable connected to the antenna and configured to supply electricity,
wherein at least part of the antenna element pattern is located between an end portion of the cable and the electronic component in a direction crossing a direction in which the end portion of the cable extends.

4. The electronic apparatus of claim 1,
wherein the electronic component is a display.

5. The electronic apparatus of claim 1,
wherein the housing comprises a first wall, and a metal second wall, the second wall located opposite to the first wall and comprising an inclined portion approaching the first wall as approaching an end of the housing, and
the antenna is located between the first wall and the inclined portion of the second wall.

6. The electronic apparatus of claim 5,
wherein the feed point is located between the end of the housing and the antenna element pattern.

7. The electronic apparatus of claim 5,
wherein the antenna element pattern is arranged substantially parallel to the first wall.

8. The electronic apparatus of claim 5,
wherein the antenna further comprises an antenna ground located between the end of the housing and the feed point.

9. The electronic apparatus of claim 8, further comprising a conductive member configured to electrically connect the antenna ground and the second wall between the end of the housing and the feed point.

10. The electronic apparatus of claim 9,
wherein the conductive member extends from the antenna ground toward the end of the housing, is bent to cover the feed point from a side opposite to the electronic component, and is attached to an inner surface of the second wall of the housing.

11. The electronic apparatus of claim 5, further comprising a cable connected to the antenna and configured to supply electricity,
wherein part of the cable is located between the antenna and an inner surface of the second wall.

12. The electronic apparatus of claim 5,
wherein the antenna element pattern is an inverted-F shaped element.

13. The electronic apparatus of claim 5,
wherein the antenna element pattern is a folded element comprising a first half portion from the feed point to an end of an antenna element, and a second half portion from the end of the antenna element to an antenna ground.

14. The electronic apparatus of claim 5,
wherein the housing comprises a corner portion, and
the antenna is located in the corner portion of the housing.
